(19) United States
(12) Patent Application Publication
(10) Pub. No.: US 2022/0140347 A1
(43) Pub. Date: May 5, 2022

(54) SELF-HEALABLE CONDUCTIVE BINDER FOR ANODE OF LITHIUM ION BATTERY AND THE PREPARATION METHOD THEREOF

(71) Applicant: Kookmin University Industry Academy Cooperation Foundation, Seoul (KR)

(72) Inventor: Ju Won JEON, Seoul (KR)

(73) Assignee: Kookmin University Industry Academy Cooperation Foundation, Seoul (KR)

(21) Appl. No.: 17/518,796

(22) Filed: Nov. 4, 2021

(30) Foreign Application Priority Data
Nov. 5, 2020 (KR) 10-2020-0147149

(51) Int. Cl. H01M 4/62; H01M 10/0525

(52) U.S. Cl. CPC H01M 4/622; H01M 2004/028; H01M 4/624; H01M 10/0525

(57) ABSTRACT

The present disclosure discloses a self-healing binder for lithium battery anodes and a method of preparing the same. The present disclosure includes a polyelectrolytes, a polyvalent chelators, and a conductive polymers, and at least one of the polyelectrolytes, the polyvalent chelators, and the conductive polymers is connected by a hydrogen bond, electrostatic bond, an ionic bond, van der Waals force, or two or more of these complementary bonds.

### CROSS-REFERENCE TO RELATED APPLICATION

This application claims priority to Korean Patent Application No. 10-2020-0147149, filed on Nov. 5, 2020 in the Korean Intellectual Property Office, the disclosure of which is incorporated herein by reference.

### BACKGROUND OF THE DISCLOSURE

### Field of the Disclosure

The present disclosure relates to a self-healing binder for lithium battery anodes and a method of preparing the same, and more particularly, to a self-healing binder for lithium battery anodes that is capable of self-healing, has excellent flexibility and elasticity, and has electrical conductivity and a method of preparing the same.

### Description of the Related Art

Lithium batteries are used in various applications due to high voltage and high energy density thereof. For example, in the field of electric vehicles (HEV, PHEV), a battery must be able to operate at a high temperature, be able to charge or discharge a large amount of electricity, and be used for a long time, and thus a lithium battery having high discharge capacity and a long lifespan is required.

Since carbon-based materials exhibit stable performance with little change in volume during charging and discharging, graphite is the most commonly used as an anode material for lithium batteries. Graphite anode materials have advantages of low price, low operating voltage, and high stability, but have a disadvantage in that the amount of charge that can be stored per mass is not large because the theoretical capacity of carbon is limited to 372 mAh/g.

On the other hand, silicon (Si) anode materials have a theoretical capacity of 3,579 mAh/g, which is 10 times higher than that of a graphite anode, exhibiting a very high theoretical capacity. In addition, silicon (Si) anode materials show a low discharge voltage (0.4 V vs. Li), and reserves thereof are also abundant. Accordingly, a silicon (Si) anode material is attracting great attention as a next-generation anode material capable of replacing graphite of a lithium battery.

However, silicon anode materials are mechanically pulverized due to a high volumetric expansion rate (˜300 volume %) thereof during charging and discharging. Accordingly, in the case of the silicon anode materials, electrical resistance in an anode rapidly increases due to occurrence of cracks and breakage of inter-particle connectivity, thereby reducing the cycle lifespan thereof.

Recently, instead of a polyvinylidene fluoride (PVDF) or sodium carboxymethyl cellulose (CMC) binder mainly used in graphite-based anodes, studies have been reported to improve the cycle characteristics of an anode by using a binder with improved mechanical properties in combination with silicon particles.

In particular, several studies have been conducted to improve the cycle performance of silicon anodes by using self-healing polymers as binders. Since self-healing polymers have the ability to self-repair cracks and mechanical damage caused by external stress or accidental cutting, the self-healing polymers can improve the reliability of related materials and increase the lifespan of a device.

However, studies using such a self-healing polymer as a binder are insufficient, and there is a limitation in preparing a polyfunctional binder having electrical conductivity, elasticity, and flexibility at the same time.

### RELATED ART DOCUMENTS

### Patent Documents

Korean Patent Application Publication No. 2020-0033198, “LITHIUM BATTERY”
Korean Patent No. 10-1604064, “ELECTRODE BINDER FOR LITHIUM BATTERY CONTAINING MELDRUM'S ACID AND LITHIUM SECONDARY BATTERY INCLUDING THE SAME”

### SUMMARY OF THE DISCLOSURE

Therefore, the present disclosure has been made in view of the above problems, and it is an object of the present disclosure to provide a polyfunctional self-healing binder for lithium battery anodes capable of self-healing a silicon anode, which is severely damaged mechanically, and having electrical conductivity by including a polyelectrolyte, a polyvalent chelator, and a conductive polymer and a method of preparing the self-healing binder.

It is another object of the present disclosure to provide an anode for lithium batteries with improved cycle characteristics and rate capability by preparing a self-healing binder having electrical conductivity by including a hydrogen bond, electrostatic bond, an ionic bond, van der Waals force, or two or more of these complementary bonds in a molecule of the self-healing binder and applying the self-healing binder to a lithium battery anode; and a method of preparing the anode for lithium batteries. In addition, the present disclosure provides a method of maximizing the charge/discharge performance of silicon by applying the prepared binder to a lithium silicon anode.

In accordance with one aspect of the present disclosure, provided is a self-healing binder for lithium battery anodes, including a polyelectrolytes, a polyvalent chelators, and a conductive polymers, wherein at least one of the polyelectrolytes, the polyvalent chelators, and the conductive polymers is connected by a hydrogen bond, electrostatic bond, an ionic bond, van der Waals force, or two or more of these complementary bonds.

The polyvalent chelator and the polyelectrolyte may be connected by the hydrogen bond, electrostatic bond and the ionic bond, and the polyvalent chelator and the conductive polymer may be connected by the hydrogen bond, electrostatic bond and the ionic bond.

The self-healing binder may have electrical conductivity.

A content of the polyelectrolyte may be 30% by mass to 95% by mass, a content of the conductive polymer may be 2% by mass to 60% by mass, and a content of the polyvalent chelator may be 3% by mass to 68% by mass.

The polyelectrolyte may include at least one of —OH, an —OZ group, a —SO₃Z group, an —OSO₃Z group, a —COOZ group, an —OPO₃Z₂ group, a —PO₃Z₂ group (Z is H⁺, Li⁺, K⁺, or Na⁺), a carbonyl group

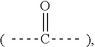

an undissociated functional group (RH), a carboxylic acid group, a sulfonic acid group, a phosphoric acid group (—PO₃H₂), an ether group (—O—), an amine group (—NH₂), and a functional group having an electric charge through protonation or deprotonation thereof.

The polyelectrolyte may include at least one of repeat units represented by Chemical Formulas 1A to 1E below:

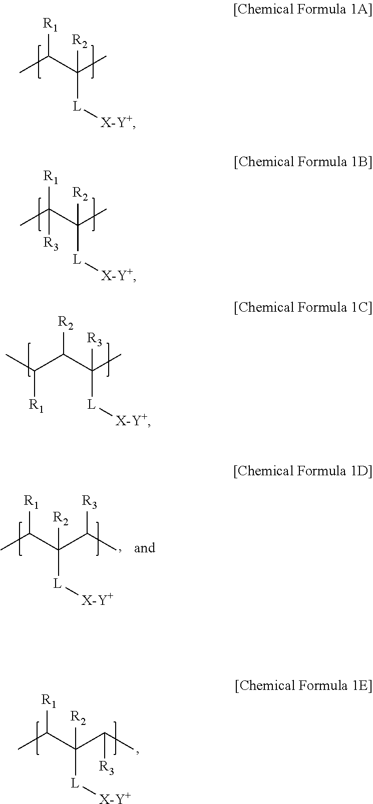

wherein R₁ to R₃ each independently represent hydrogen or a hydrocarbon group having 1 to 12 carbon atoms, L represents a bond (without separate elements), —CONH—, —COO—, or a functional group containing phenylene, X⁻ represents —O⁻, —SO₃⁻, —OSO₃⁻, —COO⁻, —OPO₃²⁻, or —PO₃², and Y⁺ represents H⁺, Li⁺, K⁺, or Na⁺.

The repeat unit of the polyelectrolyte represented by Chemical Formula 1A may be represented by Chemical Formula 1F below.

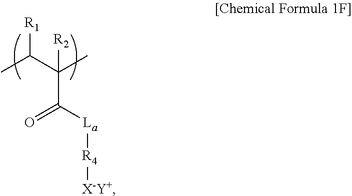

wherein La represents O or NH, R₄ represents a C1 to C6 substituted or unsubstituted alkylene group, and R₁, R₂, X⁻, and Y⁺ are each as defined in Chemical Formula 1A.

The polyelectrolyte may be poly(2-acrylamido-2-methyl-1-propanesulfonic acid) (PAAMPSA) or poly(acrylic acid) (PAA).

The polyvalent chelator may include 2 to 6 acid functional groups or base functional groups, and the acid functional groups or the base functional groups may include at least one of a phosphoric acid group (—PO₃H₂), a sulfonic acid group, an amine group, a carboxylic acid group (—COOH), and a hydroxyl group (—OH).

The polyvalent chelator may be represented by Chemical Formula 2 below:

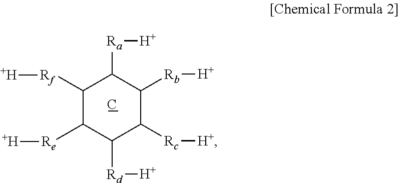

wherein ring C is a benzene ring, cyclohexane, cyclohexene, or an aggregate thereof, Rₐ, R_{b}, R_{c}, R_{d}, Rₑ, and R_{f} each independently represent hydrogen, carboxylic acid, sulfonic acid, a phosphoric acid group, or a hydroxyl group, and at least two of Rₐ, R_{b}, R_{c}, R_{d}, Rₑ, and R_{f} are each independently carboxylic acid, sulfonic acid, a phosphoric acid group, or a hydroxyl group.

The polyvalent chelator may be phytic acid (PA) or tannic acid.

The conductive polymer may be an amine-based polymer having a repeat unit represented by Chemical Formula 3A having an amine group (—NH—) in a backbone thereof or a polyaniline-based polymer having a repeat unit represented by Chemical Formula 3B:

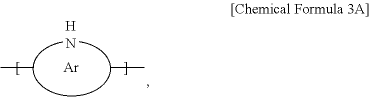

wherein Ar is a 5- to 13-membered aromatic ring including N; and

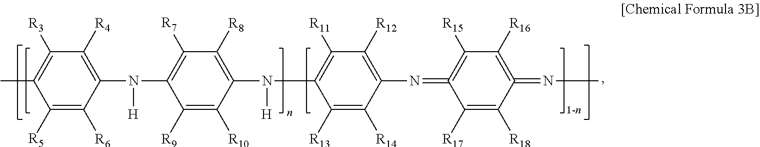

wherein n is 0 to 1, and R₃ to R₁₈ each independently represent hydrogen, C1 to C6 alkyl, C1 to C6 alkoxy, C1 to C6 haloalkyl, C1 to C6 haloalkoxy, F, Cl, Br, I, or CN, or R₃ and R₄, R₅ and R₆, R₇ and R₈, R₉ and R₁₀, R₁₁ and R₁₂, R₁₃ and R₁₄, R₁₅ and R₁₆, or R₁₇ and R₁₈ form an aromatic ring fused to a benzene ring to which R₃ and R₄, R₅ and R₆, R₇ and R₈, R₉ and R₁₀, R₁₁ and R₁₂, R₁₃ and R₁₄, R₁₅ and R₁₆, or R₁₇ and R₁₈ are attached.

The conductive polymer may include at least one monomer of pyrrole, furan, aniline, 3,4-ethylenedioxythiophene (EDOT), 3,4-ethylenedioxyselenophene (EDOS), thiophene, selenophene, and 3,4-propylenedioxythiophene-2,5-dicarboxylic acid (ProDOT).

The self-healing binder may self-heal microscale and nanoscale cracks.

In accordance with another aspect of the present disclosure, provided is a method of preparing a self-healing binder for lithium battery anodes, the method including preparing an aqueous polyelectrolyte solution including a polyelectrolyte; preparing a mixed solution by mixing a polyvalent chelator and a monomer of a conductive polymer in the aqueous polyelectrolyte solution; and adding a polymerization initiator to the mixed solution and synthesizing a self-healing binder by radical polymerization, wherein the self-healing binder includes a hydrogen bond, electrostatic bond, an ionic bond, van der Waals force, or two or more of these complementary bonds, which are reversible bonds between molecules, by the radical polymerization.

In the self-healing binder, the polyvalent chelator and the polyelectrolyte may be connected by the hydrogen bond, the electrostatic bond and the ionic bond, and the polyvalent chelator and the conductive polymer may be connected by the hydrogen bond, the electrostatic bond and the ionic bond.

In accordance with yet another aspect of the present disclosure, provided is an anode for lithium batteries including a negative electrode current collector; and a negative electrode active material layer formed on the negative electrode current collector by coating, wherein the negative electrode active material layer includes a silicon-based active material and the self-healing binder according to any one of claims 1 to 7, and the self-healing binder includes a hydrogen bond, electrostatic bond, an ionic bond, van der Waals force, or two or more of these complementary bonds, which are reversible bonds between molecules.

The self-healing binder may include a polyvalent chelator, a polyelectrolyte, and a conductive polymer, wherein the polyvalent chelator and the polyelectrolyte are connected by the hydrogen bond, electrostatic bond and the ionic bond, the conductive polymer and the polyelectrolyte are connected by the hydrogen bond, electrostatic bond and the ionic bond, and the polyvalent chelator and the conductive polymer are connected by the hydrogen bond, electrostatic bond and the ionic bond.

The negative electrode active material layer may further include a carbon-based conductor.

The anode for lithium batteries may have a thickness expansion rate of 200% or less after 20 charge/discharge cycles.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic diagram of a self-healing binder for lithium battery anodes according to an embodiment of the present disclosure;

FIG. 2 is a three-dimensional view of a self-healing binder for lithium battery anodes according to an embodiment of the present disclosure;

FIG. 3 is a flowchart for explaining a method of preparing a self-healing binder for lithium battery anodes according to an embodiment of the present disclosure;

FIG. 4 is a schematic diagram of an anode for lithium batteries according to an embodiment of the present disclosure;

FIG. 5 schematically shows a self-healing process of an anode for lithium batteries according to an embodiment of the present disclosure;

FIG. 6 is a flowchart for explaining a method of preparing an anode for lithium batteries according to an embodiment of the present disclosure;

FIG. 7 includes images showing analysis of the physical properties of a self-healing binder for lithium battery anodes according to an embodiment of the present disclosure;

FIG. 8 includes graphs showing the charge/discharge characteristics of a lithium battery including an anode for lithium batteries according to an embodiment of the present disclosure;

FIG. 9 is a graph showing the characteristics of a lithium battery including an anode for lithium batteries according to an embodiment of the present disclosure;

FIG. 10 is a graph showing the cycle characteristics of a lithium battery including an anode (SINP:CB:PANI:PAAMPSA:PA) for lithium batteries according to Example 4 of the present disclosure;

FIG. 11 is a graph showing the cycle characteristics of a lithium battery including an anode (SINP:CB:PEDOTPP) for lithium batteries according to Example 5 of the present disclosure;

FIG. 12 is a graph showing the cycle characteristics of a lithium battery including an anode (SINP:CB:PEDOT25% PAAMPSA:PA) for lithium batteries according to Example 4 of the present disclosure;

FIG. 13 is a graph showing the rate capability and the cycle characteristics of a lithium battery including an anode (SINP:CB:PEDOT4%:PAAMPSA:PA (7:1:2)) for lithium batteries according to Example 7 of the present disclosure;

FIG. 14 is a graph showing the cycle characteristics of a lithium battery including an anode (SINP:CB:P8% PP35% (7:1:2)) for lithium batteries according to Example 6 of the present disclosure;

FIG. 15 is a graph showing the cycle characteristics of a lithium battery including an anode for lithium batteries according to a comparative example;

FIG. 16 is a graph showing the cycle characteristics of a lithium battery including an anode for lithium batteries according to Example 7 of the present disclosure;

FIG. 17 a graph showing the cycle characteristics of a lithium battery including an anode for lithium batteries according to Example 8 of the present disclosure;

FIG. 18 is a graph showing the cycle characteristics of a lithium battery including an anode for lithium batteries according to Example 9 of the present disclosure;

FIG. 19 is a graph showing the cycle characteristics of a lithium battery including an anode for lithium batteries according to Example 10 of the present disclosure;

FIG. 20 is a graph showing the cycle characteristics of a lithium battery including an anode for lithium batteries according to Example 11 of the present disclosure; and

FIGS. 21A-21D include images showing the thickness expansion rate of an anode (PAA) for lithium batteries according to a comparative example and the thickness expansion rate of an anode (PED:PAA:PA) for lithium batteries according to Example 7 of the present disclosure.

### DETAILED DESCRIPTION OF THE DISCLOSURE

The present disclosure will now be described more fully with reference to the accompanying drawings and contents disclosed in the drawings. However, the present disclosure should not be construed as limited to the exemplary embodiments described herein.

The terms used in the present specification are used to explain a specific exemplary embodiment and not to limit the present inventive concept. Thus, the expression of singularity in the present specification includes the expression of plurality unless clearly specified otherwise in context. It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless mentioned otherwise or clearly inferred from context, the expression “x uses a or b” means any one of natural inclusive permutations.

In addition, as used in the description of the disclosure and the appended claims, the singular form “a” or “an” is intended to include the plural forms as well, unless context clearly indicates otherwise.

Although terms used in the specification are selected from terms generally used in related technical fields, other terms may be used according to technical development and/or due to change, practices, priorities of technicians, etc. Therefore, it should not be understood that terms used below limit the technical spirit of the present disclosure, and it should be understood that the terms are exemplified to describe embodiments of the present disclosure.

Also, some of the terms used herein may be arbitrarily chosen by the present applicant. In this case, these terms are defined in detail below. Accordingly, the specific terms used herein should be understood based on the unique meanings thereof and the whole context of the present disclosure.

Unless defined otherwise, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In addition, in the following description of the present disclosure, a detailed description of known functions and configurations incorporated herein will be omitted when it may make the subject matter of the present disclosure unclear. The terms used in the specification are defined in consideration of functions used in the present disclosure, and can be changed according to the intent or conventionally used methods of clients, operators, and users. Accordingly, definitions of the terms should be understood on the basis of the entire description of the present specification.

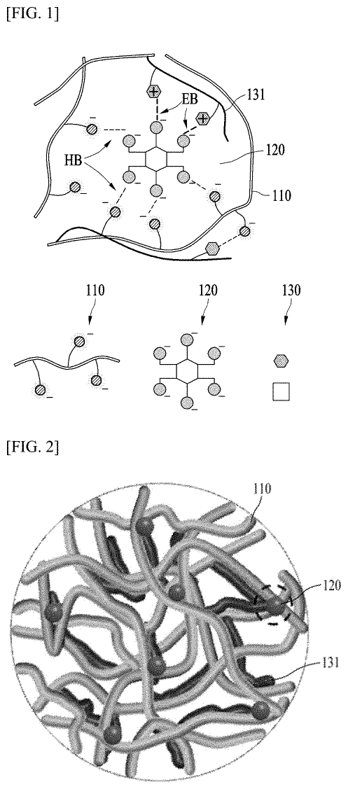

FIG. 1 is a schematic diagram of a self-healing binder for lithium battery anodes according to an embodiment of the present disclosure, and FIG. 2 is a three-dimensional view of a self-healing binder for lithium battery anodes according to an embodiment of the present disclosure.

The self-healing binder for lithium battery anodes according to an embodiment of the present disclosure includes a polyelectrolytes 110, a polyvalent chelators 120, and a conductive polymers 131, and at least one of the polyelectrolytes 110, the polyvalent chelators 120, and the conductive polymers 131 is connected by a hydrogen bond, electrostatic bond, an ionic bond, van der Waals force, or two or more of these complementary bonds.

More specifically, since the polyvalent chelator 120 includes elements such as carbon, hydrogen, oxygen, nitrogen, and phosphorus, the polyelectrolyte 110 includes elements such as carbon, oxygen, nitrogen, and hydrogen, and the conductive polymer 131 includes elements such as nitrogen, carbon, sulfur, and hydrogen, hydrogen bonds between nitrogen, oxygen, and hydrogen may be formed between the polyelectrolyte 110, the polyvalent chelator 120, and the conductive polymer 131, electrostatic bond and ionic bonds may be formed between charged functional groups, and van der Waals force may act between carbon chains.

Preferably, in the self-healing binder for lithium battery anodes according to an embodiment of the present disclosure, the polyvalent chelator 120 and the polyelectrolyte 110 may be mainly connected by a hydrogen bond, electrostatic bond and an ionic bond, the polyvalent chelator 120 and the conductive polymer 131 may be mainly connected by a hydrogen bond, electrostatic bond and an ionic bond, and the conductive polymer 131 and the polyelectrolyte 110 may be mainly connected by a hydrogen bond, electrostatic bond and an ionic bond.

In addition, in the self-healing binder for lithium battery anodes according to an embodiment of the present disclosure, when the number of carbon atoms in the polyelectrolyte 110, the polyvalent chelator 120, and the conductive polymer 131 is 10 or more, the polyelectrolyte 110, the polyvalent chelator 120, and the conductive polymer 131 may be connected by van der Waals force to provide self-healing performance.

The polyelectrolyte 110 may provide a lithium ion-conductive pathway, and may electrostatically interact with a positively charged conductive polymer 130.

The polyelectrolyte 110 may include at least one of —OH, an —OZ group, a —SO₃Z group, an —OSO₃Z group, a —COOZ group, an —OPO₃Z₂ group, a —PO₃Z₂ group (Z is H⁺, Li⁺, K⁺, or Na⁺), a carbonyl group

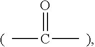

an undissociated functional group (RH), a carboxylic acid group, a sulfonic acid group, a phosphoric acid group (—PO₃H₂), an ether group (—O—), an amine group (—NH₂), and a functional group having an electric charge through protonation or deprotonation thereof.

More specifically, the polyelectrolyte 110 is a polymer having an anionic group and a corresponding cation in a repeat unit, the anionic group may be —O⁻, —SO³⁻, —OSO₃⁻, —COO⁻, —OPO₃²⁻, or —PO₃²⁻, and the corresponding cation may be H⁺, Li⁺, K⁻, or Na⁺. The backbone of the polyelectrolyte 110 may be a saturated alkane or carbohydrate.

The polyelectrolyte 110 having a saturated alkane as the backbone thereof may have a repeat unit represented by at least one of Chemical Formulas 1A to 1E below.

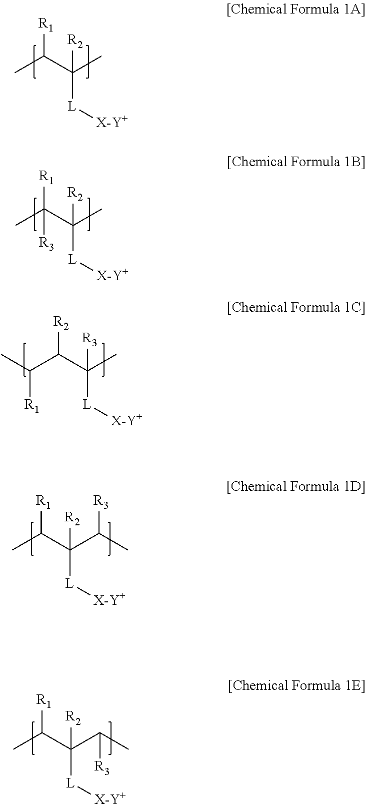

In Chemical Formulas 1A to 1E, R₁ to R₃ may independently represent hydrogen or a hydrocarbon group having 1 to 12 carbon atoms, L may represent a bond (without separate elements), —CONH—, —COO—, or a functional group containing phenylene, X⁻ may represent —O⁻, —SO₃⁻, —OSO₃⁻, —COO⁻, —OPO₃²⁻, or —PO₃²⁻, and Y⁺ may represent H⁺, Li⁺, K⁺, or Na⁺.

In this case, the meaning of ‘L is a bond’ may mean that X is directly bonded to the backbone without L being bonded.

However, when X⁻ is —OPO₃²⁻, X⁻Y⁺ may be —OPO₃H₂ or

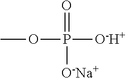

and when X⁻ is —PO₃²⁻, X⁻Y⁺ may be —PO₃H₂ or

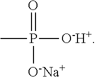

The anionic polymer represented by Chemical Formula 1A may have a repeat unit represented by Chemical Formula 1F below.

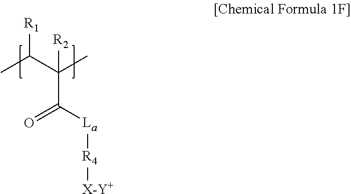

In Chemical Formula 1F, Lₐ may represent 0 or NH, R₄ may represent a C1 to C6 substituted or unsubstituted alkylene group, and R₁, R₂, R₃, X⁻, and Y⁺ are as defined in Chemical Formulas 1A to 1E.

According to an embodiment, the repeat unit of the polyelectrolyte 110 having a saturated alkane as the backbone thereof may be represented by combinations of Chemical Formulas 1A to 1F. For example, the repeat unit of the polyelectrolyte 110 having a saturated alkane as the backbone thereof may include Chemical Formulas 1A to 1F.

Specifically, the polyelectrolyte 110 represented by Chemical Formula 1A may be polyvinylalcohol (PVA) (R₁ and R₂ represent hydrogen, L represents a bond, and X⁻Y⁺ represents OH), polyacrylic acid (R₁ and R₂ represent hydrogen, L represents a bond, X⁻Y⁺ represents COOH), polymethacrylic acid (R₁ represents hydrogen, R₂ represents a methyl group, L represents a bond, and X⁻Y⁺ represents COOH), polystyrene sulfonate (PSS) (R₁ and R₂ represent hydrogen, L represents phenylene, and X⁻Y⁺ represents SO₃H), poly(2-acrylamido-2-methyl-1-propanesulfonic acid) (PAAMPSA) (R₁ and R₂ represent hydrogen, L represents —CONHC(CH₃)₂CH₂—, and X⁻Y⁺ represents SO₃H), 2-(sulfoxy)ethyl methacrylate (R₁ represents hydrogen, R₂ represents a methyl group, L represents —COOCH₂CH₂—, and X⁻Y⁺ represents —OSO₃H), or sodium poly(vinyl phosphate) (R₁ and R₂ represent hydrogen, L represents a bond, and X⁻Y⁺ represents

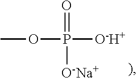

and the polyelectrolyte 110 represented by Chemical Formula 1F may be PAAMPSA (R₁ and R₂ represent hydrogen, La represents —NH—, R₃ represents —C(CH₃)₂CH₂—, and X⁻Y⁺ represents SO₃H) or sulfooxyethyl methacrylate (R₁ represents hydrogen, R₂ represents a methyl group, La represents —O—, R₃ represents —CH₂CH₂—, and X⁻Y⁺ represents —OSO₃H).

Specifically, the polyelectrolyte 110 having carbohydrate as the backbone thereof may be carboxy methyl cellulose (CMC), agarose, or chitosan.

According to an embodiment, the polyelectrolyte 110 may include at least one of a sulfonic acid group (—SO₃H), a carboxylic acid group (—COOH), a phosphoric acid group (—PO₃H₂), an ether group (—O—), an amine group (—NH₂), and a functional group having an electric charge through protonation or deprotonation thereof.

In addition, the polyelectrolyte 110 may be a non-conjugated anionic polyelectrolyte, and the non-conjugated anionic polyelectrolyte may mean a polyelectrolyte having a negative charge due to loss of a cation or a hydrogen ion in a chemical functional group of a polymer chain or a polyelectrolyte having a positive charge due to gain of a cation or a hydrogen ion in a chemical functional group of a polymer chain.

Preferably, the polyelectrolyte 110 may be poly(2-acrylamido-2-methyl-1-propanesulfonic acid) (PAAMPSA) or poly(acrylic acid) (PAA).

The polyvalent chelator 120 may serve as a physical crosslinking agent that connects both the polyelectrolyte 110 and the conductive polymer 131 through a hydrogen bond, electrostatic bond, an ionic bond, van der Waals force, or two or more of these complementary bonds, and may additionally interact with the conductive polymer 131 through a hydrogen bond, electrostatic bond, an ionic bond, van der Waals force, or two or more of these complementary bonds.

Preferably, the polyvalent chelator 120 serves as a physical crosslinking agent that connects both the polyelectrolyte 110 and the conductive polymer 131 through an electrostatic bond, ionic bond or a hydrogen bond, and additionally interacts with the conductive polymer 131 through an electrostatic bond, ionic bond or a hydrogen bond.

More specifically, since the polyvalent chelator 120 includes elements such as carbon, hydrogen, oxygen, nitrogen, and phosphorus, the polyelectrolyte 110 includes elements such as carbon, oxygen, nitrogen, and hydrogen, and the conductive polymer 131 includes elements such as nitrogen, carbon, sulfur, and hydrogen, hydrogen bonds between nitrogen, oxygen, and hydrogen may be formed between the polyelectrolyte 110, the polyvalent chelator 120, and the conductive polymer 131, ionic bonds may be formed between charged functional groups, and van der Waals force may act between carbon chains.

Preferably, the polyvalent chelator 120 and the polyelectrolyte 110 may be connected mainly by hydrogen bonds, electrostatic bonds and ionic bonds, and the polyvalent chelator 120 and the conductive polymer 131 may be connected mainly by hydrogen bonds, electrostatic bonds and ionic bonds.

In addition, in the self-healing binder for lithium battery anodes, when the number of carbon atoms in the polyelectrolyte 110, the polyvalent chelator 120, and the conductive polymer 131 is 10 or more, the polyelectrolyte 110, the polyvalent chelator 120, and the conductive polymer 131 may be connected by van der Waals force to provide self-healing performance.

The polyvalent chelator 130 may include a plurality of acid or base functional groups. For example, the polyvalent chelator 130 may be a single molecule having two or more acid or base functional groups, specifically a single molecule having 2 to 6 acid or base functional groups. Specifically, the acid functional group may be carboxylic acid, sulfonic acid, or phosphoric acid, and the base functional group may be amine.

When the polyvalent chelator 130 includes an acid functional groups, the dissociation constant of the polyvalent chelator 130 may be greater than that of the polyelectrolyte 110. The polyvalent chelator 130 may be an aminopolycarboxylic acid, citric acid, or a substance represented by Chemical Formula 2 below.

An aminopolycarboxylic acid containing three or more carboxylic acids may be 1,2-diaminopropane-N,N,N′,N′-tetraacetic acid (PDTA), ethylenediaminetetraacetic acid (EDTA), methylglycinediacetic acid (MGDA), nitrilotriacetic acid (NTA), N-(2-carboxyethyl)iminodiacetic acid (β-ADA), diethylenetriaminepentaacetic acid (DTPA), 1,4,7,10-tetraazacyclododecane-1,4,7,10-tetraacetic acid (DOTA), ethylenediamaine-N,N-dimalonic acid (EDDM), iminodisuccinic acid (ISA), ethylenediamine-N,N-disuccinic acid (EDDS), aspartic acid diethoxy succinate (AES), or a combination thereof.

The polyvalent chelator 120 may include at least one of a sulfonic acid group, a phosphoric acid group (—PO₃H₂), an amine group, a carboxylic acid group (—COOH), and a hydroxyl group (—OH).

The polyvalent chelator 120 may be represented by Chemical Formula 2 below.

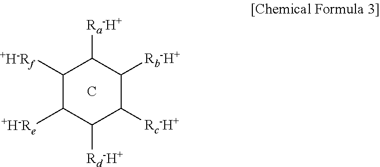

In Chemical Formula 3, ring C may be a benzene ring, cyclohexane, cyclohexene, or an aggregate thereof, Rₐ, R_{b}, R_{c}, R_{d}, Rₑ, and R_{f} may each independently represent hydrogen, carboxylic acid, sulfonic acid, a phosphoric acid group, or a hydroxyl group, and at least two of Rₐ, R_{b}, R_{c}, R_{d}, Rₑ, and R_{f} may each independently represent carboxylic acid, sulfonic acid, or a phosphoric acid group.

The polyvalent chelator 130 represented by Chemical Formula 2 may be a benzene carboxylic acid, e.g., hemimellitic acid, trimellitic acid, trimesic acid, prehnitic acid, mellophanic acid, pyromellitic acid, benzene pentacarboxylic acid, mellitic acid, and the like shown below.

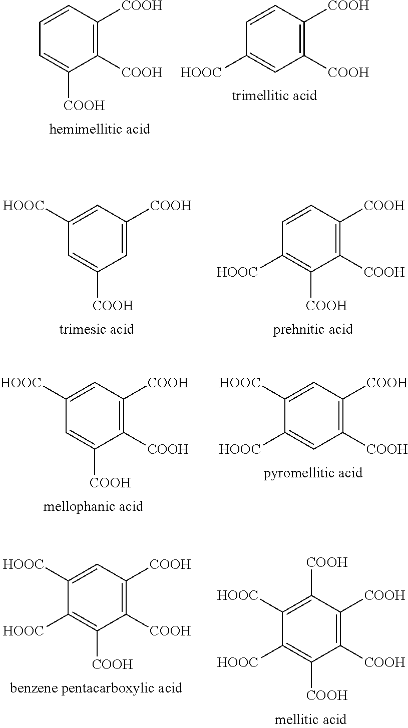

Preferably, the polyvalent chelator 130 is phytic acid (PA) or tannic acid.

The conductive polymer 131 may be an amine-based polymer having a repeat unit represented by Chemical Formula 3A having an amine group (—NH—) in a backbone thereof or a polyaniline-based polymer having a repeat unit represented by Chemical Formula 3B.

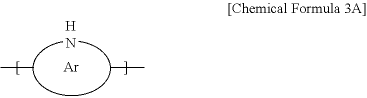

In Chemical Formula 3A, Ar may be a 5- to 13-membered aromatic ring including N, e.g., 5-membered pyrrole, 9-membered indole, 13-membered carbazole.

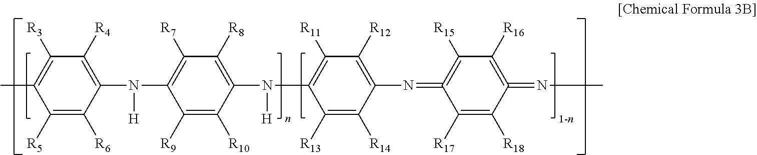

In Chemical Formula 3B, n may be 0 to 1, e.g., 0.4 to 0.6, and R₃ to R₁₈ may each independently be hydrogen, C1 to C6 alkyl, C1 to C6 alkoxy, C1 to C6 haloalkyl, C1 to C6 haloalkoxy, F, Cl, Br, I, or CN.

Alternatively, R₃ and R₄, R₅ and R₆, R₇ and R₈, R₉ and R₁₀, R₁₁ and R₁₂, R₁₃ and R₁₄, R₁₅ and R₁₆, or R₁₇ and R₁₈ may form an aromatic ring fused to a benzene ring to which R₃ and R₄, R₅ and R₆, R₇ and R₈, R₉ and R₁₀, R₁₁ and R₁₂, R₁₃ and R₁₄, R₁₅ and R₁₆, or R₁₇ and R₁₈ are attached.

In particular, in Chemical Formula 3B, R₃ to Rug all represent hydrogen, and n may represent a polyaniline emeraldine base salt of 0.5.

The conductive polymer 131 may include at least one monomer of pyrrole, furan, aniline, 3,4-ethylenedioxythiophene (EDOT), 3,4-ethylenedioxyselenophene (EDOS), thiophene, selenophene, and 3,4-propylenedioxythiophene-2,5-dicarboxylic acid (ProDOT, or may include substituents of the conductive polymer 131 described above.

Preferably, the conductive polymer 131 includes at least one of polypyrrole, polycarbazole, polyindole, poly 3,4-ethylenedioxythiophene (PEDOT), polyaniline (PANT), and a polyaniline emeraldine base salt.

In addition, the conductive polymer 131 may be a conjugated polymer having a conjugated structure.

Accordingly, in the self-healing binder for lithium battery anodes according to an embodiment of the present disclosure, at least one reversible hydrogen bond, electrostatic bond, ionic bond, van der Waals force, or two or more of these complementary bonds may be included in a molecule.

A hydrogen bond, electrostatic bond, an ionic bond, van der Waals force, or two or more of these complementary bonds included in a molecule of the self-healing binder for lithium battery anodes according to an embodiment of the present disclosure may be easily broken and recombined to dissipate energy due to strain, thereby obtaining elasticity, flexibility, and self-healing performance.

In addition, a hydrogen bond, electrostatic bond, an ionic bond, van der Waals force, or two or more of these complementary bonds included in a molecule of the self-healing binder for lithium battery anodes according to an embodiment of the present disclosure may bind and dissociate dynamically at room temperature, thereby further improving self-healing performance.

Preferably, in the self-healing binder for lithium battery anodes according to an embodiment of the present disclosure, the polyvalent chelator 120 and the polyelectrolyte 110 may be connected mainly by hydrogen bonds, electrostatic bonds and ionic bonds, and the polyvalent chelator 120 and the conductive polymer 131 may be connected mainly by hydrogen bonds, electrostatic bonds and ionic bonds.

In addition, in the self-healing binder for lithium battery anodes according to an embodiment of the present disclosure, when the number of carbon atoms in the polyelectrolyte 110, the polyvalent chelator 120, and the conductive polymer 131 is 10 or more, he polyelectrolyte 110, the polyvalent chelator 120, and the conductive polymer 131 may be connected by van der Waals force to provide self-healing performance.

Accordingly, the self-healing binder for lithium battery anodes according to an embodiment of the present disclosure may have flexibility, elasticity, and self-healing at the same time by including both fluid and reversible hydrogen bond (HB), electrostatic bond and ionic bond (EB) within the molecule.

For example, in the self-healing binder for lithium battery anodes according to an embodiment of the present disclosure, when poly(2-acrylamido-2-methyl-1-propanesulfonic acid) (PAAMPSA) is used as the polyelectrolyte 110, phytic acid (PA) is used as the polyvalent chelator 120, and polyaniline (PANI) is used as the conductive polymer 131, the amine group of the PANT backbone may form an ionic bond (EB) by electrostatic interaction with the sulfonic acid group of PAAMPSA, and may form a hydrogen bond (HB), electrostatic bond and an ionic bond (EB) with the phosphoric acid group of PA.

In addition, the amide and sulfonic acid groups of PAAMPSA and the phosphoric acid group of PA may additionally form a hydrogen bond (HB).

In the self-healing binder for lithium battery anodes according to an embodiment of the present disclosure, according to the contents of each of the polyelectrolyte 110, the polyvalent chelator 120, and the conductive polymer 131, charge storage capacity, rate capability, capacity retention rate, or discharge efficiency may be adjusted.

In addition, in the self-healing binder for lithium battery anodes according to an embodiment of the present disclosure, by adjusting the mass ratio between the polyelectrolyte 110, the polyvalent chelator 120, and the conductive polymer 131, the electrical conductivity or self-healing performance of the self-healing binder may be controlled.

Preferably, the content of the polyelectrolyte 110 may be 30% by mass to 95% by mass, the content of the conductive polymer 131 may be 2% by mass to 60% by mass, and the content of the polyvalent chelator 120 may be 3% by mass to 68% by mass.

When the mass ratio is out of the above range, the self-healing properties of the polymer binder may disappear or the electrical conductivity thereof may be greatly reduced.

Accordingly, the self-healing binder for lithium battery anodes according to an embodiment of the present disclosure may self-heal a silicon-based anode, which is severely damaged mechanically, by including the polyelectrolyte 110, the polyvalent chelator 120, and the conductive polymer 130, thereby improving the storage capacity, output characteristics, and cycle characteristics of the silicon anode.

In addition, the self-healing binder for lithium battery anodes according to an embodiment of the present disclosure may have an elasticity of up to 750%.

In addition, the binder used in the anode for lithium batteries according to an embodiment of the present disclosure may self-heal 300% of strain, and may perform self-healing performance even after 50 or more cycles.

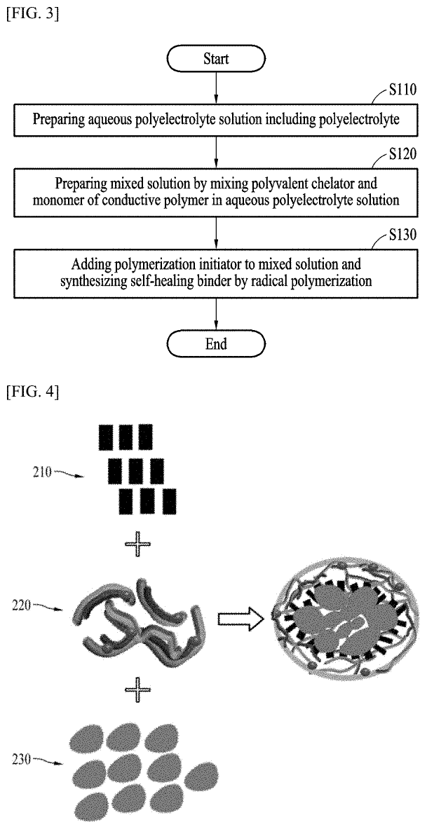

FIG. 3 is a flowchart for explaining a method of preparing a self-healing binder for lithium battery anodes according to an embodiment of the present disclosure.

Some components of the method of preparing a self-healing binder for lithium battery anodes according to an embodiment of the present disclosure are the same as the components of the self-healing binder for lithium battery anodes according to an embodiment of the present disclosure described with reference to FIG. 1. Thus, description of the same components will be omitted.

The method of preparing a self-healing binder for lithium battery anodes according to an embodiment of the present disclosure includes step S110 of preparing an aqueous polyelectrolyte solution including a polyelectrolyte, step S120 of preparing a mixed solution by mixing a polyvalent chelator and a monomer of a conductive polymer in the aqueous polyelectrolyte solution, and step S130 of adding a polymerization initiator to the mixed solution and synthesizing a self-healing binder by radical polymerization.

In the method of preparing a self-healing binder for lithium battery anodes according to an embodiment of the present disclosure, step S110 of preparing an aqueous polyelectrolyte solution including a polyelectrolyte is performed.

For example, poly(2-acrylamido-2-methyl-1-propanesulfonic acid) (PAAMPSA) or polyacrylic acid (PAA) may be used as the polyelectrolyte 110.

The polyelectrolyte may mean a polyelectrolyte having a negative charge due to loss of a cation or a hydrogen ion in a chemical functional group of a polymer chain or a polyelectrolyte having a positive charge due to gain of a cation or a hydrogen ion in a chemical functional group of a polymer chain.

Then, in the method of preparing a self-healing binder for lithium battery anodes according to an embodiment of the present disclosure, step S120 of preparing a mixed solution by mixing a polyvalent chelator and a monomer of a conductive polymer in the aqueous polyelectrolyte solution is performed.

30% by mass to 95% by mass of the polyelectrolyte (or the aqueous polyelectrolyte solution) may be included in the mixed solution.

For example, the polyelectrolyte may be poly(2-acrylamido-2-methyl-1-propanesulfonic acid) (PAAMPSA) or poly(acrylic acid) (PAA).

3% by mass to 68% by mass of the polyvalent chelator may be included in the mixed solution. When the polyvalent chelator is included in an amount less than 3% by mass, self-healing performance and elasticity may be reduced. When the polyvalent chelator is included in an amount exceeding 68% by mass, electrical conductivity may be reduced.

For example, phytic acid (PA) or tannic acid may be used as the polyvalent chelator.

2% by mass to 60% by mass of the conductive polymer may be included in the mixed solution. When the conductive polymer is included in an amount less than 2% by mass, electrical conductivity may be significantly reduced. When the conductive polymer is included in an amount exceeding 60% by mass, self-healing performance may be deteriorated.

The conductive polymer may include at least one of polypyrrole, polycarbazole, polyindole, poly 3,4-ethylenedioxythiophene (PEDOT), polyaniline (PANT), and a polyaniline emeraldine base salt.

Accordingly, when the polyelectrolyte, the polyvalent chelator, and the conductive polymer are included within the above-described ranges, all of electrical conductivity, elasticity, and self-healing performance may be achieved. However, when the contents of the polyelectrolyte, the polyvalent chelator, and the conductive polymer are out of the above-described ranges, any one of electrical conductivity, elasticity, and self-healing performance may be significantly reduced.

Finally, in the method of preparing a self-healing binder for lithium battery anodes according to an embodiment of the present disclosure, step S130 of adding a polymerization initiator to the mixed solution and synthesizing a self-healing binder by radical polymerization is performed.

The polymerization initiator may include at least one of ammonium persulfate, sodium persulfate, potassium persulfate, 2,2-azobis-(2-amidinopropane)dihydrochloride, 2,2-azobis-(N,N-dimethylene)isobutyramidine dihydrochloride, 2-(carbamoyl azo)isobutyronitrile, 2,2-azobis[2-(2-imidazolin-2-yl)propane] dihydrochloride, and 4,4-azobis-(4-cyanovaleric acid), preferably, ammonium persulfate.

In the method of preparing a self-healing binder for lithium battery anodes according to an embodiment of the present disclosure, since the self-healing binder is prepared by radical polymerization, a hydrogen bond, electrostatic bond, an ionic bond, van der Waals force, or two or more of these complementary bonds, which are fluid and reversible between the molecules of the self-healing binder, may be included.

Accordingly, the self-healing binder for lithium battery anodes according to an embodiment of the present disclosure may have conductivity, flexibility, elasticity, and self-healing characteristics at the same time by including a hydrogen bond, electrostatic bond, an ionic bond, van der Waals force, or two or more of these complementary bonds, which are fluid and reversible in a molecule.

In addition, since the self-healing binder for lithium battery anodes according to an embodiment of the present disclosure has excellent dispersibility in water, an aqueous slurry anode may be prepared by using water as a solvent without an additional organic solvent. In addition, since expensive organic solvents are excluded, process cost may be reduced, and an anode may be prepared through an eco-friendly process that is less harmful to the human body.

FIG. 4 is a schematic diagram of an anode for lithium batteries according to an embodiment of the present disclosure.

The anode for lithium batteries according to an embodiment of the present disclosure includes a negative electrode current collector and a negative electrode active material layer formed on the negative electrode current collector by coating. The negative electrode active material layer includes a silicon-based active material 230 and a self-healing binder 220 for lithium batteries according to an embodiment of the present disclosure.

The negative electrode current collector may include at least one of copper foil, nickel foil, stainless steel foil, titanium foil, nickel foam, copper foam, and a polymer substrate coated with a conductive metal.

The silicon-based active material 230 included in the negative electrode active material layer is a material capable of insertion/desorption of lithium ions, and may include at least one of silicon (Si), silicon oxides represented by SiO_{X} (0<X≤2), and metal silicates.

According to an embodiment, the silicon-based active material 230 may be a silicon-carbon composite including a silicon-based material, e.g., a composite material composed of silicon and carbon or a composite material composed of SiO_{X} (0<X≤2) and carbon.

Silicon particles may have a nanometer-scale or micrometer-scale diameter.

In addition, the nanoscale silicon-based active material 230 may be used to minimize cracks due to volume expansion.

The self-healing binder is the same as the self-healing binder for lithium battery anodes according to an embodiment of the present disclosure, and repeated description thereof is omitted.

In the case of the anode for lithium batteries according to an embodiment of the present disclosure, a self-healing binder having self-healing performance, flexibility, and elasticity at the same time may be prepared by including a hydrogen bond, electrostatic bond, an ionic bond, van der Waals force, or two or more of these complementary bonds in a molecule of the self-healing binder, and cycle characteristics and rate capability may be improved by applying the self-healing binder to a lithium battery anode.

Since the anode for lithium batteries according to an embodiment of the present disclosure includes a self-healing binder having electrical conductivity by including a hydrogen bond, electrostatic bond, an ionic bond, van der Waals force, or two or more of these complementary bonds in a molecule of the self-healing binder, resistance generated when electrons and lithium ions move to a silicon anode during charging and discharging may be reduced, thereby improving cycle characteristics, electricity storage capacity, and rate capability.

Since the anode for lithium batteries according to an embodiment of the present disclosure may use the self-healing binder for lithium battery anodes according to an embodiment of the present disclosure instead of a carbon-based conductor 210, the anode for lithium batteries may not include the carbon-based conductor 210.

According to an embodiment, the anode for lithium batteries according to an embodiment of the present disclosure may further include the carbon-based conductor 210 in the negative electrode active material layer.

The carbon-based conductor 210 included in the negative electrode active material layer may be a material capable of insertion/desorption of lithium ions, and may include at least one of graphite, hard carbon, soft carbon, carbon black, acetylene black, ketjen black, super-P, graphene, and fibrous carbon, preferably, graphite, carbon black, or super-P.

Accordingly, the negative electrode active material layer of the anode for lithium batteries according to an embodiment of the present disclosure may be an active material, and may include at least one of a silicon-based active material, a silicon/graphite composite active material, and a graphite-based active material.

When the self-healing binder for lithium battery anodes according to an embodiment of the present disclosure is used in combination with the silicon-based active material, the anode for lithium batteries according to an embodiment of the present disclosure may have a thickness expansion rate of 200% or less after 20 charge/discharge cycles.

In addition, the anode for lithium batteries according to an embodiment of the present disclosure may be used in a lithium battery, and the lithium battery may have any one of a cylindrical shape, a prismatic shape, and a pouch shape. However, the present disclosure is not limited thereto, and the lithium battery may have various shapes.

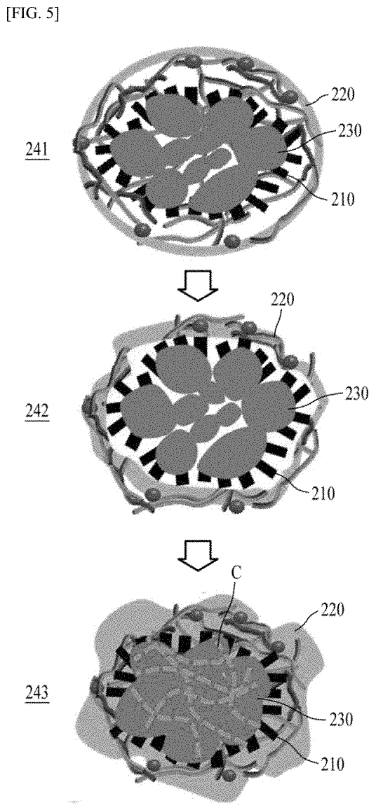

FIG. 5 schematically shows a self-healing process of an anode for lithium batteries according to an embodiment of the present disclosure.

During charging and discharging of a lithium battery, lithium ions are intercalated into the silicon-based active material 230 and de-intercalated therefrom. At this time, the silicon-based active material 230 may form an alloy with the lithium ions, causing volume expansion and contraction (241).

In the process of expanding the volume of the silicon-based active material 230, silicon is destroyed and connectivity is broken, and microscale cracks (C) may be generated (243) in the negative electrode active material layer due to desorption and pulverization. As a result, the negative electrode active material layer is separated from the negative electrode current collector, thereby reducing the service life of a lithium battery.

However, in the case of the anode for lithium batteries according to an embodiment of the present disclosure, since the self-healing binder 220 for lithium batteries according to an embodiment of the present disclosure is included in the negative electrode active material layer, during intercalation of lithium ions, cracks having a size of 1 μm to 30 μm generated during lithiation of an anode, where expansion of the silicon-based active material 230 by 300% occurs, may be healed. Thus, occurrence of cracks may be minimized. In addition, even when connectivity is partially broken, nanoscale and microscale cracks may self-heal due to self-healing characteristics 242 of the self-healing binder. By recovering the existing mechanical and electrical properties, the lifespan characteristics of the anode may be improved.

In addition, since the self-healing binder 220 for lithium batteries according to an embodiment of the present disclosure has conductivity, the charge storage and rate capability of an anode may also be improved.

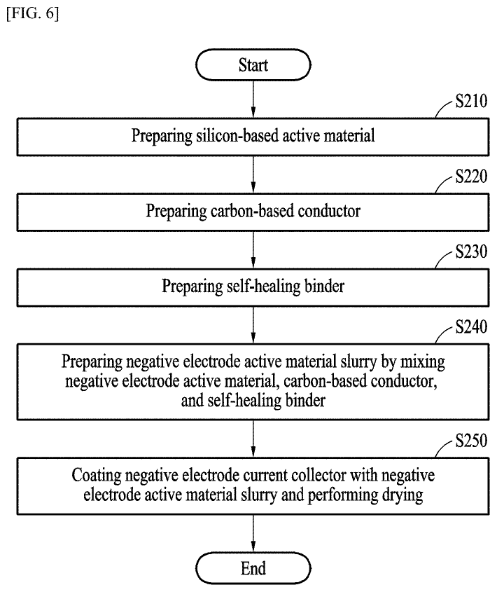

FIG. 6 is a flowchart for explaining a method of preparing an anode for lithium batteries according to an embodiment of the present disclosure.

The method of preparing an anode for lithium batteries according to an embodiment of the present disclosure includes step S210 of preparing a silicon-based active material, step S230 of preparing a self-healing binder according to the method of preparing a self-healing binder for lithium batteries according to an embodiment of the present disclosure, step S240 of preparing negative electrode active material slurry by mixing the silicon-based active material and the self-healing binder, and step S250 of coating a negative electrode current collector with the negative electrode active material slurry and performing drying.

According to the method of preparing an anode for lithium batteries according to an embodiment of the present disclosure, a carbon-based conductor may be replaced with the self-healing binder for lithium battery anodes according to an embodiment of the present disclosure, and thus the carbon-based conductor may not be included.

According to an embodiment, in the method of preparing an anode for lithium batteries according to an embodiment of the present disclosure, the negative electrode active material layer may further include a carbon-based conductor.

Accordingly, in the method of preparing an anode for lithium batteries according to an embodiment of the present disclosure, step S210 of preparing a silicon-based active material, step S220 of preparing a carbon-based conductor, and step S230 of preparing a self-healing binder according to the method of preparing a self-healing binder for lithium batteries according to an embodiment of the present disclosure may be performed.

In the method of preparing an anode for lithium batteries according to an embodiment of the present disclosure, step S210 of preparing a silicon-based active material, step S220 of preparing a carbon-based conductor, and step S230 of preparing a self-healing binder according to the method of preparing a self-healing binder for lithium batteries according to an embodiment of the present disclosure may be performed.

Preferably, silicon nanoparticles are used as the silicon-based active material, and graphite, carbon black, or super-P is used as the carbon-based conductor.

The self-healing binder is prepared by the method of preparing a self-healing binder for lithium batteries according to an embodiment of the present disclosure, and thus description of the same components will be omitted.

In the method of preparing an anode for lithium batteries according to an embodiment of the present disclosure, step S240 of preparing negative electrode active material slurry by mixing the silicon-based active material and the self-healing binder is performed.

According to an embodiment, the method of preparing an anode for lithium batteries according to an embodiment of the present disclosure may further include step S220 of preparing a carbon-based conductor.

Accordingly, in the method of preparing an anode for lithium batteries according to an embodiment of the present disclosure, step S240 of preparing negative electrode active material slurry by mixing the silicon-based active material, the carbon-based conductor, and the self-healing binder may be performed.

The content of the silicon-based active material may be 4% by mass to 97% by mass, the content of the carbon-based conductor may be 2% by mass to 95% by mass, and the content of the self-healing binder may be 0.3% by mass to 25% by mass. When the mass ratio is out of the above-described range, at least one performance of self-healing, elasticity, and electrical conductivity may be degraded.

The method of preparing an anode for lithium batteries according to an embodiment of the present disclosure includes step S250 of coating a negative electrode current collector with the negative electrode active material slurry and performing drying.

As a method of coating the negative electrode current collector with the negative electrode active material slurry, methods (e.g., spray coating, dipping, and the like) that do not adversely affect the physical properties of the negative electrode active material slurry may be used. When these requirements are satisfied, any coating method may be used, and detailed description thereof will be omitted since those skilled in the art are well aware of this.

In addition, since the self-healing binder for lithium battery anodes according to an embodiment of the present disclosure has excellent dispersibility in water, an aqueous slurry anode may be prepared by using water as a solvent without an additional organic solvent. In addition, since expensive organic solvents are excluded, process cost may be reduced, and an anode may be prepared through an eco-friendly process that is less harmful to the human body.

### [Example 1]: PANI: Synthesis of PAAMPSA-PA Self-Healing Polymer

0.17 g of aniline and 1 g of phytic acid (PA) were added to 10 g of an aqueous poly(2-acrylamido-2-methyl-1-propanesulfonic acid) (PAAMPSA) solution and mixed. Then, the mixture was cooled using an ice bath (<5° C.) to obtain a dispersed liquid of ANI:PAAMPSA-PA (8.0:69:23 wt %).

At the same time, 0.36 g of ammonium persulfate (APS) was added to 1 ml of deionized water to obtain an aqueous APS solution, and the aqueous APS solution was cooled at <˜5° C.

Then, the aqueous APS solution was added to the dispersed liquid of PANI:PAAMPSA-PA (8.0:69:23 wt %), and polymerization was performed for 12 hours to synthesize PANI:PAAMPSA-PA.

### Example 2

An anode film was prepared by a rolling-blade method.

A silicon-based active material (A) using 42 mg of silicon nanoparticles (SiNP), a self-healing binder (B) using 59 g of PANI:PAAMPSA-PA and 33 g of PANI:PAA-PA, and a carbon-based conductor (C) using 6 mg of carbon super-P were uniformly mixed using an agate mortar.

The silicon-based active material (A), the carbon-based conductor (B), and the self-healing binder (C) were mixed in a mass ratio of 70:20:10 to prepare uniform negative electrode active material slurry.

Copper (Cu) foil of 3×5 cm² was applied onto the negative electrode active material slurry using a stainless rod to form an anode thick film.

The anode film was dried at 150° C. for 4 hours at a temperature rate of 5° C.min⁻¹ in a vacuum oven to remove water molecules, and then the anode film was trimmed to form a circle-shaped film having an area of 1.77 cm².

The negative electrode active material slurry had a mass loading of ˜1 mgcm⁻².

### [Example 3]: SINP/CB/PEDOT:PAAMPSA:PA

0.17 g of 3,4-ethylenedioxythine (EDOT) and 1 g of phytic acid (PA) were added to 10 g of an aqueous poly(2-acrylamido-2-methyl-1-propanesulfonic acid) (PAAMPSA) solution and mixed. Then, the mixture was cooled using an ice bath (<5° C.) to obtain a dispersed liquid of PEDOT:PAAMPSA:PA (8.0:69:23 wt %).

At the same time, 0.36 g of ammonium persulfate (APS) was added to 1 ml of deionized water to obtain an aqueous APS solution, and the aqueous APS solution was cooled at <˜5° C.

Then, an aqueous APS solution was added to the dispersed liquid of PEDOT:PAAMPSA-PA (8.0:69:23 wt %), and polymerization was performed for 12 hours to synthesize PEDOT:PAAMPSA-PA.

An anode film was prepared by a rolling-blade method.

The silicon-based active material (A) using 42 mg of silicon nanoparticles (SiNP), the self-healing binder (B) using 59 g of PEDOT:PAAMPSA-PA and 33 g of PEDOT:PAA-PA, and the carbon-based conductor (C) using 6 mg of carbon super-P were uniformly mixed using an agate mortar.

The silicon-based active material (A), the carbon-based conductor (B), and the self-healing binder (C) were mixed in a mass ratio of 70:20:10 to prepare uniform negative electrode active material slurry.

Copper (Cu) foil of 3×5 cm² was applied onto the negative electrode active material slurry using a stainless rod to form an anode thick film.

The anode film was dried at 150° C. for 4 hours at a temperature rate of 5° C.min⁻¹ in a vacuum oven to remove water molecules, and then the anode film was trimmed to form a circle-shaped film having an area of 1.77 cm².

The negative electrode active material slurry had a mass loading of ˜1 mgcm⁻².

### [Example 4]: SINP:CB:PEDOT25%:PAAMPSA:PA

The same preparation procedure as in Example 3 was performed, except that 0.53125 g of EDOT was included.

### [Example 5]: SINP:CB:PEDOT4% PMAAPSA:PA (7:1:2)

The same preparation procedure as in Example 3 was performed, except that 0.085 g of EDOT was included.

### [Example 6]: SINP:CB:PEDOT8%:PAAMPSA:P35% (7:1:2)

The same preparation procedure as in Example 3 was performed, except that 1.5217 g of PA was included.

### [Comparative Example]: PAA

A commercially available polymer was used as the PAA.

### [Example 7]: 8% PED:PAA:PA

0.4058 g of 3,4-ethylenedioxythiophene (EDOT) and 2.333 g of phytic acid (PA, 50 wt %) were added to 10 g of an aqueous poly(acrylic acid) (PPA, 35 wt %) solution and mixed. Then, the mixture was cooled using an ice bath (<5° C.) to obtain a dispersed liquid of PEDOT:PAA:PA (8.0:69:23 wt %).

At the same time, 0.554 g of ammonium persulfate (APS) was added to 1 ml of deionized water to obtain an aqueous APS solution, and the aqueous APS solution was cooled at <˜5° C.

Then, the aqueous APS solution was added to the dispersed liquid of EDOT:PAA:PA (8.0:69:23 wt %), and polymerization was performed for 12 hours to synthesize PEDOT:PAA:PA (8.0:69:23 wt %).

### [Example 8]: 12% PED:PAA:PA

The same preparation procedure as in Example 7 was performed, except that 0.6087 g of 3,4-ethylenedioxythiophene (EDOT) was included.

### [Example 9]: 16% PED:PAA:PA

The same preparation procedure as in Example 7 was performed, except that 0.8116 g of 3,4-ethylenedioxythiophene (EDOT) was included.

### [Example 10]: 20% PED:PAA:PA

The same preparation procedure as in Example 7 was performed, except that 1.0145 g of 3,4-ethylenedioxythiophene (EDOT) was included.

### [Example 11]: 30% PED:PAA:PA

The same preparation procedure as in Example 7 was performed, except that 1.52175 g of 3,4-ethylenedioxythiophene (EDOT) was included.

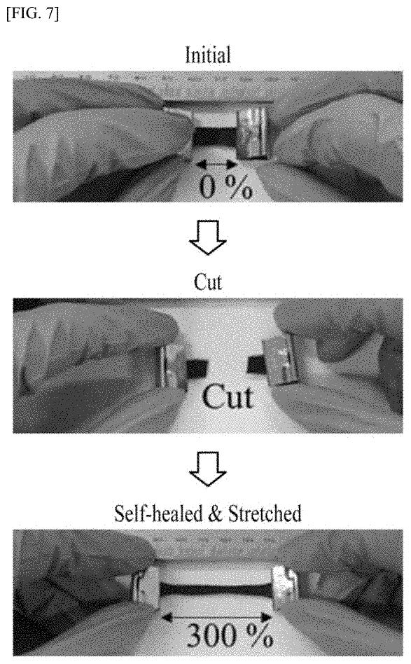

FIG. 7 includes images showing analysis of the physical properties of a self-healing binder for lithium battery anodes according to an embodiment of the present disclosure.

Referring to FIG. 7, when a film coated with negative electrode active material slurry including the self-healing binder for lithium battery anodes according to an embodiment of the present disclosure is cut using scissors, the film is self-healing and spontaneously reconnects without external stimuli such as force, light, or heat

In addition, the film coated with negative electrode active material slurry including the self-healing binder for lithium battery anodes according to an embodiment of the present disclosure is capable of self-healing a cut site of several tens of micrometers.

In addition, even when the film coated with negative electrode active material slurry including the self-healing binder for lithium battery anodes according to an embodiment of the present disclosure is stretched, the film does not break and has elasticity, and the film is self-healing and spontaneously reconnects without external stimuli such as force, light, or heat.

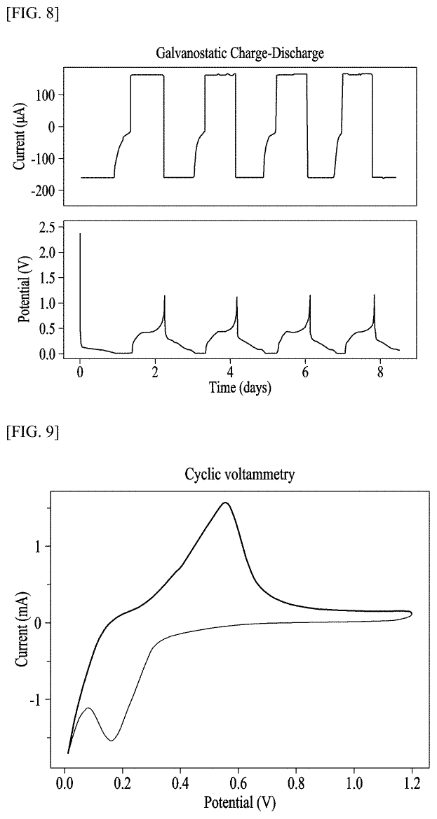

FIG. 8 is a graph showing the charge/discharge characteristics of a lithium battery including the anode for lithium batteries according to Example 2 of the present disclosure.

Referring to FIG. 8, when constant current-constant voltage charging and constant current discharging experiments were conducted, at an anode operating voltage of 0.01 to 1 V (vs. Li), an anode showed stable charge/discharge performance.

FIG. 9 is a graph showing the characteristics of a lithium battery including the anode for lithium batteries according to Example 2 of the present disclosure.

Referring to FIG. 9, it can be seen that lithium ions are lithiated at 0.2 V and delithiated near 0.5 V by cycle voltammetry showing current values when voltage is changed linearly.

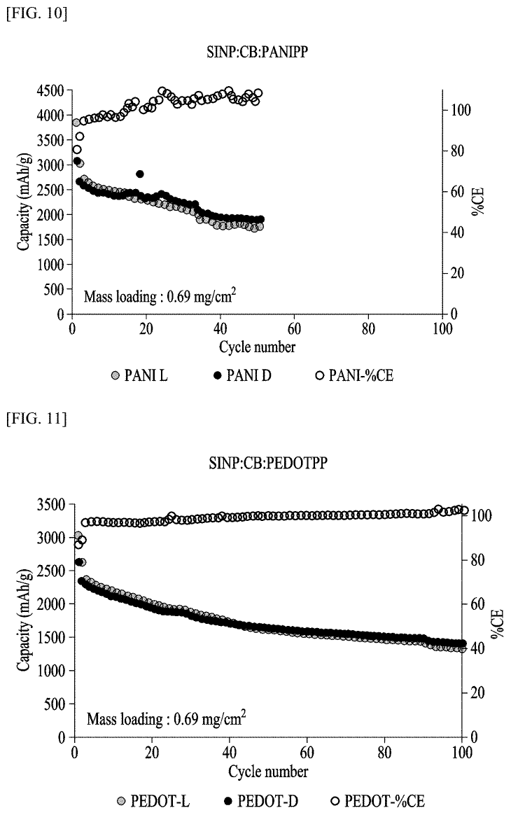

FIG. 10 is a graph showing the cycle characteristics of a lithium battery including the anode (SINP:CB:PANI:PAAMPSA:PA) for lithium batteries according to Example 1 of the present disclosure.

Referring to FIG. 10, during 50 cycles of charging and discharging, self-healing of microcracks generated by lithiation (PANI L), delithiation (PANI D), and volume change of efficient silicon nanoparticles is performed, and thus desorption due to cracking of a negative electrode active material layer is suppressed even during repeated charging and discharging. Thus, a high capacity retention rate is observed even after 50 cycles of charging and discharging.

FIG. 11 is a graph showing the cycle characteristics of a lithium battery including the anode (SINP/CB/PEDOT:PAAMPSA:PA) for lithium batteries according to Example 3 of the present disclosure.

Referring to FIG. 11, during 100 cycles of charging and discharging, self-healing of microcracks generated by lithiation (PANI L), delithiation (PANI D), and volume change of efficient silicon nanoparticles is performed, and thus desorption due to cracking of a negative electrode active material layer is suppressed even during repeated charging and discharging. Thus, a high capacity retention rate is observed even after 100 cycles of charging and discharging.

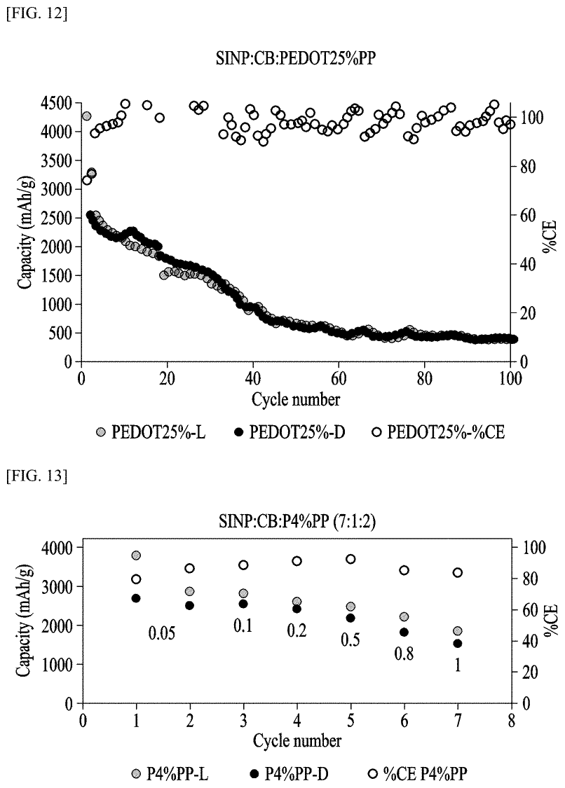

FIG. 12 is a graph showing the cycle characteristics of a lithium battery including an anode (SINP:CB:PEDOT25% PAAMPSA:PA) for lithium batteries according to Example 4 of the present disclosure.

Referring to FIG. 12, during 100 cycles of charging and discharging, capacity retention rate does not show a significant difference from other samples, which is evidence that the type and component of a conductive polymer greatly affects the cycle characteristics of a silicon anode.

Table 1 shows the cycle characteristics of lithium batteries including the anodes for lithium batteries according to Examples 1, 3, and 4 of the present disclosure.

TABLE 1

| | Discharge capacity | | Initial |
|---|---|---|---|
| | (Remained capacity, | | efficiency |
| Samples | mAb/g) | | (% ICE) |
| Example 1 | 1883 | (50 cycles) | 80.55 |
| (SINP:CB:PANI:PAAMPSA:PA) | | | |
| Example 3 | 1380 | (100 cycles) | 86.97 |
| (SIMP/CB/PEDOT:PAAMPSA:PA) | | | |
| Example 4 | 374 | (100 cycles) | 74.48 |
| (SINP:CB:PEDOT25% PAAMPSA:PA) | | | |

Accordingly, referring to FIGS. 10 to 12 and Table 1, compared to a lithium battery including the anode for lithium batteries according to Example 1 of the present disclosure, the cycle characteristics of a lithium battery including the anode for lithium batteries according to Example 3 of the present disclosure are improved due to self-healing performance thereof.

In addition, compared to a lithium battery including the anode for lithium batteries according to Example 4 of the present disclosure, in the case of a lithium battery including the anode for lithium batteries according to Example 3 of the present disclosure, when the content of a conductive polymer increases, initial efficiency and cycle characteristics are degraded.

FIG. 13 is a graph showing the cycle characteristics of a lithium battery including the anode (SINP:CB:PEDOT4%:PAAMPSA:PA (7:1:2)) for lithium batteries according to Example 5 of the present disclosure, and Table 2 shows the cycle characteristics of the lithium battery including the anode (SINP:CB:PEDOT4%:PAAMPSA:PA (7:1:2)) for lithium batteries according to Example 5 of the present disclosure.

TABLE 2

| Charge/discharge | | | Initial efficiency |
|---|---|---|---|
| rate (C-rate) | Lithiation | Delithiation | (% CE) |
| 0.05 | 3630.217 | 2570.548 | 70.80976 |
| 0.05 | 2751.463 | 2397.855 | 87.14836 |
| 0.1 | 2751.463 | 2397.855 | 87.14836 |
| 0.2 | 2494.93 | 2324.905 | 93.18517 |
| 0.5 | 2361.765 | 2097.766 | 88.82195 |
| 0.8 | 2122.265 | 1747.729 | 82.35209 |
| 1 | 1768.358 | 1477.402 | 83.54653 |

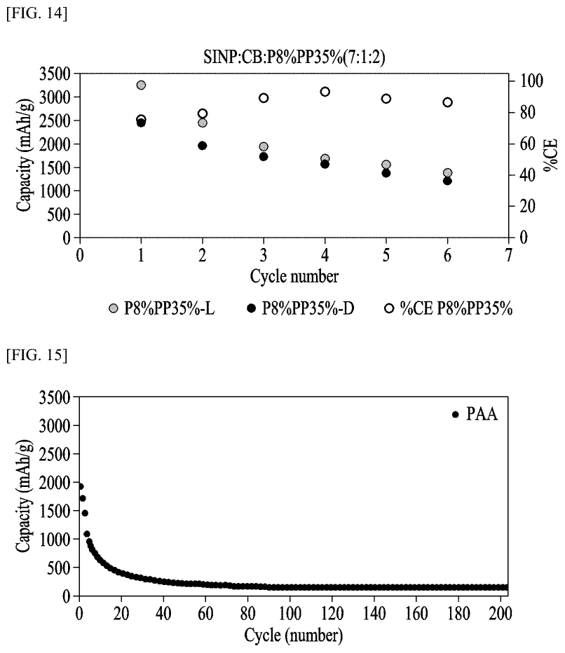

FIG. 14 is a graph showing the cycle characteristics of a lithium battery including the anode (SINP:CB:PEDOT8%:PAAMPSA:PA35% (7:1:2)) for lithium batteries according to Example 6 of the present disclosure, and Table 3 shows the cycle characteristics of the lithium battery including the anode (SINP:CB:PEDOT8%:PAAMPSA:PA35% (7:1:2)) for lithium batteries according to Example 5 of the present disclosure.

TABLE 3

| Charge/discharge | | | Initial efficiency |
|---|---|---|---|
| rate (C-rate) | Lithiation | Delithiation | (% CE) |
| 0.05 | 3260.865 | 2458.432 | 75.39202 |
| 0.05 | 2451.259 | 1941.53 | 79.20542 |
| 0.1 | 1921.689 | 1717.039 | 89.35053 |
| 0.2 | 1679.138 | 1564.721 | 93.18596 |
| 0.5 | 1548.935 | 1373.508 | 88.67435 |
| 0.8 | 1372.723 | 1185.153 | 86.33593 |

Referring to FIGS. 13 and 14 and Tables 2 and 3, in the case of a binder having a high content of a conductive polymer (PEDOT) and a high content of a polyvalent chelator (PA), electricity storage capacity and rate capability are further reduced.

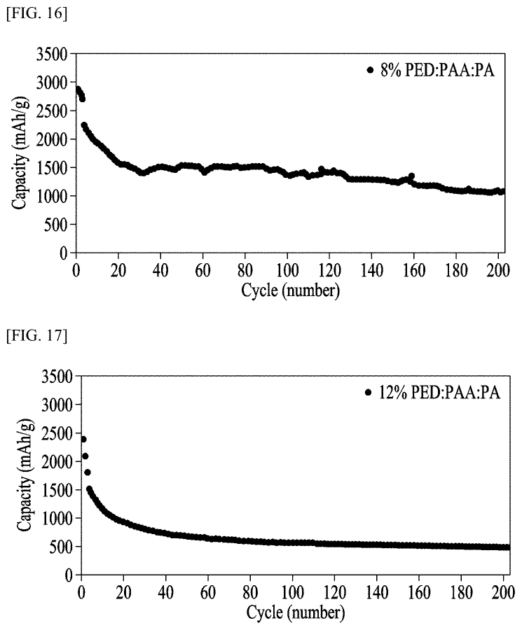

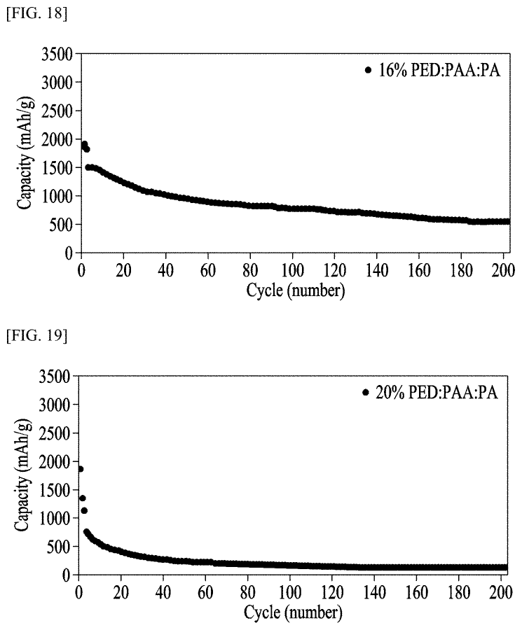

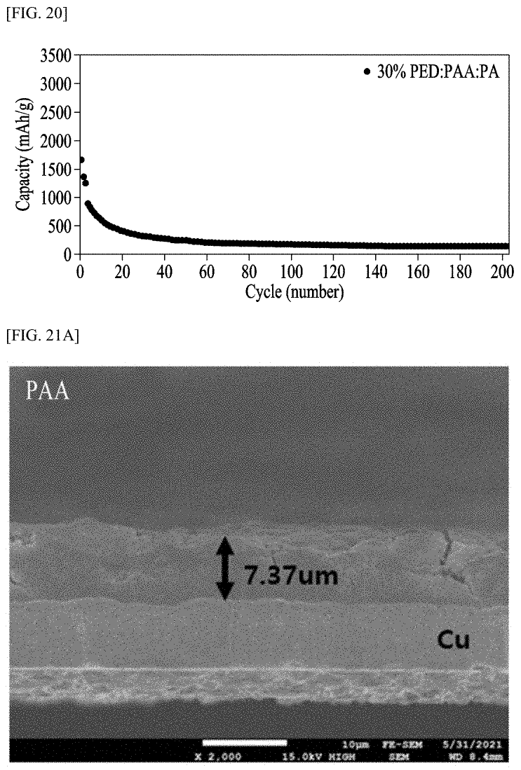

FIG. 15 is a graph showing the cycle characteristics of a lithium battery including an anode for lithium batteries according to the comparative example, and FIGS. 16 to 20 are graphs showing the cycle characteristics of a lithium battery depending on the content of a conductive polymer.

Referring to FIGS. 15 to 20, in the case of the lithium battery including the anode for lithium batteries according to an embodiment of the present disclosure, during 100 cycles of charging and discharging, self-healing of microcracks generated by lithiation (PANI L), delithiation (PANI D), and volume change of efficient silicon nanoparticles is performed, and thus desorption due to cracking of a negative electrode active material layer is suppressed even during repeated charging and discharging. Thus, a high capacity retention rate is observed compared to the lithium battery including the anode for lithium batteries according to the comparative example.

In addition, in the case of the lithium battery including the anode for lithium batteries according to an embodiment of the present disclosure, when the content of a conductive polymer increases, initial efficiency and cycle characteristics are degraded. Accordingly, it can be seen that optimization of the amount of the conductive polymer is required, and efficiency is maximized when the amount of the conductive polymer is 20% or less.

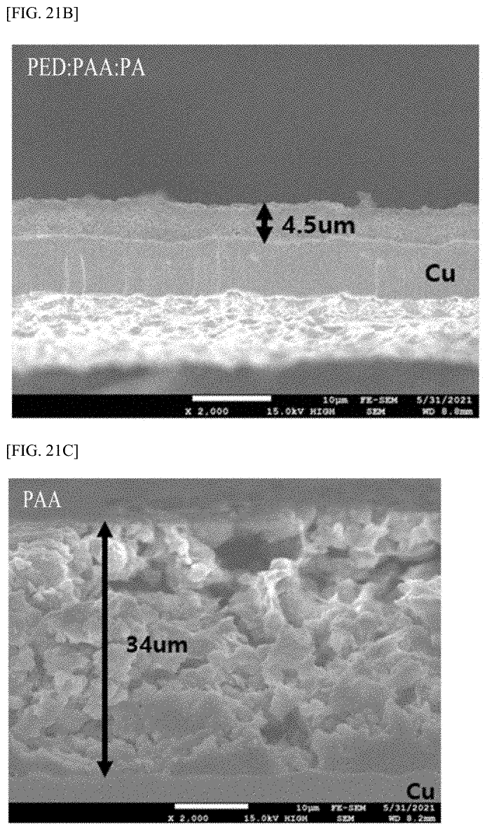

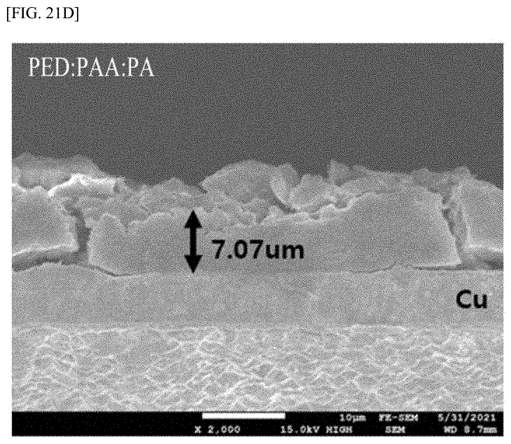

FIGS. 21A-21D include images showing the thickness expansion rate of an anode (PAA) for lithium batteries according to a comparative example and the thickness expansion rate of an anode (PED:PAA:PA) for lithium batteries according to Example 7 of the present disclosure.

Referring to FIGS. 21A-21D, the thickness of the anode (PAA) for lithium batteries according to the comparative example increases from 7.37 μm to 34 μm, showing a high thickness expansion rate of 361%. Thus, the anode is mechanically pulverized, causing cracks and breaking of inter-particle connectivity.

On the other hand, since the anode (PED:PAA:PA) for lithium batteries according to Example 7 of the present disclosure includes the self-healing binder and the silicon-based active material according to an embodiment of the present disclosure, the thickness of the anode increases from 4.5 μm to 7.07 μm, showing a low thickness expansion rate of 57% (after 20 charging/discharging cycles, thickness expansion rate: ˜200%). This results indicate that self-healing of nanoscale cracks and microscale cracks is performed.

According to an embodiment of the present disclosure, the present disclosure can provide a self-healing binder for lithium battery anodes capable of self-healing a silicon-based anode or an anode containing silicon, which is severely damaged mechanically, by including a polyelectrolyte, a polyvalent chelator, and a conductive polymer and a method of preparing the self-healing binder.

According to an embodiment of the present disclosure, the present disclosure can provide an anode for lithium batteries with improved cycle characteristics and rate capability by preparing a self-healing binder having self-healing performance, flexibility, and elasticity by including a hydrogen bond, electrostatic bond, an ionic bond, van der Waals force, or two or more of these complementary bonds in a molecule of a self-healing binder and applying the self-healing binder to a lithium battery anode; and a method of preparing the anode for lithium batteries.

Although the present disclosure has been described with reference to limited embodiments and drawings, it should be understood by those skilled in the art that various changes and modifications may be made therein. Therefore, the scope of the present disclosure should not be limited by the embodiments, but should be determined by the following claims and equivalents to the following claims.

### DESCRIPTION OF SYMBOLS

110: POLYELECTROLYTE
120: POLYVALENT CHELATOR
130: MONOMER OF CONDUCTIVE POLYMER
131: CONDUCTIVE POLYMER
210: CARBON-BASED CONDUCTOR
220: SELF-HEALING POLYMER
230: SILICON-BASED ACTIVE MATERIAL

What is claimed is:

1. A self-healing binder for lithium battery anodes, comprising a polyelectrolytes, a polyvalents chelator, and a conductive polymers, wherein at least one of the polyelectrolytes, the polyvalent chelators, and the conductive polymers is connected by a hydrogen bond, electrostatic bond, an ionic bond, van der Waals force, or two or more of these complementary bonds.

2. The self-healing binder according to claim 1, wherein the polyvalent chelator and the polyelectrolyte are connected by the hydrogen bond, electrostatic bond and the ionic bond, and the polyvalent chelator and the conductive polymer are connected by the hydrogen bond, electrostatic bond and the ionic bond.

3. The self-healing binder according to claim 1, wherein the self-healing binder has electrical conductivity.

4. The self-healing binder according to claim 1, wherein a content of the polyelectrolyte is 30% by mass to 95% by mass, a content of the conductive polymer is 2% by mass to 60% by mass, and a content of the polyvalent chelator is 3% by mass to 68% by mass.

5. The self-healing binder according to claim 1, wherein the polyelectrolyte comprises at least one of —OH, an —OZ group, a —SO₃Z group, an −OSO₃Z group, a —COOZ group, an —OPO₃Z₂ group, a —PO₃Z₂ group (Z is 14+, Li⁺, K⁺, or Na⁺), a carbonyl group 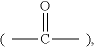
an undissociated functional group (RH), a carboxylic acid group, a sulfonic acid group, a phosphoric acid group (—PO₃H₂), an ether group (—O—), an amine group (—NH₂), and a functional group having an electric charge through protonation or deprotonation thereof.

6. The self-healing binder according to claim 1, wherein the polyelectrolyte comprises at least one of repeat units represented by Chemical Formulas 1A to 1E below: 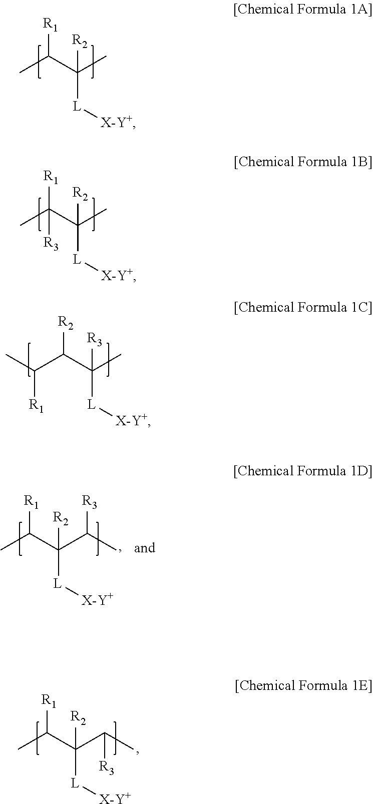
wherein R₁ to R₃ each independently represent hydrogen or a hydrocarbon group having 1 to 12 carbon atoms, L represents a bond (without separate elements), —CONH—, —COO—, or a functional group containing phenylene, X⁻ represents —O⁻, —SO₃⁻, —OSO₃⁻, —COO⁻, —OPO₃²⁻, or —PO₃²⁻, and Y⁺ represents H⁺, Li⁺, K⁺, or Na⁺.

7. The self-healing binder according to claim 6, wherein the repeat unit of the polyelectrolyte represented by Chemical Formula 1A is represented by Chemical Formula 1F below: 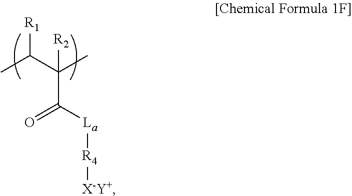
wherein Lₐ represents O or NH, R₄ represents a C1 to C6 substituted or unsubstituted alkylene group, and R₁, R₂, X⁻, and Y⁺ are each as defined in Chemical Formula 1A.

8. The self-healing binder according to claim 1, wherein the polyelectrolyte is poly(2-acrylamido-2-methyl-1-propanesulfonic acid) (PAAMPSA) or poly(acrylic acid) (PAA).

9. The self-healing binder according to claim 1, wherein the polyvalent chelator comprises 2 to 6 acid functional groups or base functional groups, and the acid functional groups or the base functional groups comprise at least one of a phosphoric acid group (—PO₃H₂), a sulfonic acid group, an amine group, a carboxylic acid group (—COOH), and a hydroxyl group (—OH).

10. The self-healing binder according to claim 1, wherein the polyvalent chelator is represented by Chemical Formula 2 below: 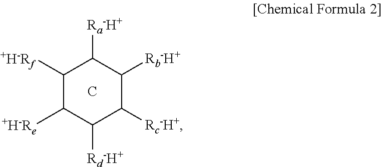
wherein ring C is a benzene ring, cyclohexane, cyclohexene, or an aggregate thereof, Rₐ, R_{b}, R_{c}, R_{d}, Rₑ, and R_{f} each independently represent hydrogen, carboxylic acid, sulfonic acid, a phosphoric acid group, or a hydroxyl group, and at least two of Rₐ, R_{b}, Rₑ, R_{d}, Rₑ, and R_{f} are each independently carboxylic acid, sulfonic acid, a phosphoric acid group, or a hydroxyl group.

11. The self-healing binder according to claim 1, wherein the polyvalent chelator is phytic acid (PA) or tannic acid.

12. The self-healing binder according to claim 1, wherein the conductive polymer is an amine-based polymer having a repeat unit represented by Chemical Formula 3A having an amine group (—NH—) in a backbone thereof or a polyaniline-based polymer having a repeat unit represented by Chemical Formula 3B: 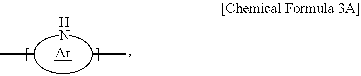
wherein Ar is a 5- to 13-membered aromatic ring comprising N; and 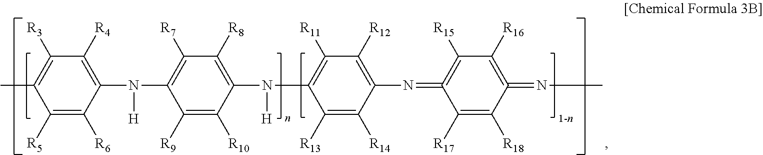
wherein n is 0 to 1, and R₃ to R₁₈ each independently represent hydrogen, C1 to C6 alkyl, C1 to C6 alkoxy, C1 to C6 haloalkyl, C1 to C6 haloalkoxy, F, Cl, Br, I, or CN, or R₃ and R₄, R₅ and R₆, R₇ and R₈, R₉ and R₁₀, R₁₁ and R₁₂, R₁₃ and R₁₄, R₁₅ and R₁₆, or R₁₇ and R₁₈ form an aromatic ring fused to a benzene ring to which R₃ and R₄, R₅ and R₆, R₇ and R₈, R₉ and R₁₀, R₁₁ and R₁₂, R₁₃ and R₁₄, R₁₅ and R₁₆, or R₁₇ and R₁₈ are attached.

13. The self-healing binder according to claim 1, wherein the conductive polymer comprises at least one monomer of pyrrole, furan, aniline, 3,4-ethylenedioxythiophene (EDOT), 3,4-ethylenedioxyselenophene (EDOS), thiophene, selenophene, and 3,4-propylenedioxythiophene-2,5-dicarboxylic acid (ProDOT).

14. The self-healing binder according to claim 1, wherein the self-healing binder self-heals microscale and nanoscale cracks.

15. A method of preparing a self-healing binder for lithium battery anodes, comprising:
preparing an aqueous polyelectrolyte solution comprising a polyelectrolyte;
preparing a mixed solution by mixing a polyvalent chelator and a monomer of a conductive polymer in the aqueous polyelectrolyte solution; and
adding a polymerization initiator to the mixed solution and synthesizing a self-healing binder by radical polymerization,
wherein the self-healing binder comprises a hydrogen bond, electrostatic bond, an ionic bond, van der Waals force, or two or more of these complementary bonds, which are reversible bonds between molecules, by the radical polymerization.

16. The method according to claim 15, wherein, in the self-healing binder, the polyvalent chelator and the polyelectrolyte are connected by the hydrogen bond, electrostatic bond and the ionic bond, and the polyvalent chelator and the conductive polymer are connected by the hydrogen bond, electrostatic bond and the ionic bond.

17. An anode for lithium batteries, comprising:
a negative electrode current collector; and
a negative electrode active material layer formed on the negative electrode current collector by coating,
wherein the negative electrode active material layer comprises a silicon-based active material and the self-healing binder according to claim 1, and
the self-healing binder comprises a hydrogen bond, electrostatic bond, an ionic bond, van der Waals force, or two or more of these complementary bonds, which are reversible bonds between molecules.

18. The anode according to claim 17, wherein the self-healing binder comprises a polyvalent chelator, a polyelectrolyte, and a conductive polymer,
wherein the polyvalent chelator and the polyelectrolyte are connected by the hydrogen bond, electrostatic bond and the ionic bond,
the conductive polymer and the polyelectrolyte are connected by the hydrogen bond, electrostatic bond and the ionic bond, and
the polyvalent chelator and the conductive polymer are connected by the hydrogen, electrostatic bond and the ionic bond.

19. The anode according to claim 17, wherein the negative electrode active material layer further comprises a carbon-based conductor.

20. The anode according to claim 17, wherein the anode for lithium batteries has a thickness expansion rate of 200% or less after 20 charge/discharge cycles.
